(19) United States
(12) Patent Application Publication
(10) Pub. No.: US 2016/0246748 A1
(43) Pub. Date: Aug. 25, 2016

(54) ENHANCED CONNECTION PATHWAY ARCHITECTURES FOR SAS SYSTEMS

(71) Applicant: AVAGO TECHNOLOGIES GENERAL IP (SINGAPORE) PTE. LTD., SINGAPORE (SG)

(72) Inventors: Louis Henry Odenwald, Wichita, KS (US); Benjamin Knoblauch, Wichita, KS (US); Erik Paulsen, Colorado Springs, CO (US)

(21) Appl. No.: 14/627,066

(22) Filed: Feb. 20, 2015

(51) Int. Cl. G06F 13/40; G06F 13/42

(52) U.S. Cl. CPC G06F 13/4022; G06F 13/4282; G06F 13/4068

(57) ABSTRACT

Methods and structure for enhancing connection pathways for storage controllers. An exemplary system includes a stack of Serial Attached Small Computer System Interface (SAS) expanders that are coupled to each other in series. The stack includes two end expanders that are endpoints of the stack which are directly coupled to only one other SAS expander of the stack, and a plurality of middle expanders that are each directly coupled to two other SAS expanders of the stack. The system further includes a plurality of storage devices that are coupled to the SAS expanders of the stack, and a SAS storage controller comprising multiple SAS ports that are each directly coupled to a different SAS expander of the stack, wherein at least one of the multiple SAS ports is directly coupled to a middle expander of the stack.

### FIELD OF THE INVENTION

The invention relates generally to data storage, and more specifically to storage systems.

### BACKGROUND

Serial Attached Small Computer System Interface (SAS) storage systems utilize a variety of devices and components in order to store and retrieve data for a host. For example, a storage system may include a storage controller that receives host requests directed to a logical volume, and translates those host requests into SAS Input/Output (I/O) operations for individual storage devices. The storage controller may then establish SAS connections in order to transmit the SAS I/O operations to the storage devices via one or more expanders. In such a storage system, users continue to seek out enhanced techniques for increasing both the reliability of the storage system and the latency of access to data maintained by the storage system.

### SUMMARY

Systems and methods herein provide for SAS storage controllers that are asymmetrically and/or redundantly connected to a stack of serially coupled SAS expanders. In this manner, a variety of redundant connection pathways of different lengths are available to the storage controller to contact a storage device via the expanders. Furthermore, the shortest path length between the storage controller and the storage devices is beneficially reduced, reducing the latency of access to data on the storage system.

One exemplary embodiment is a system that includes a stack of Serial Attached Small Computer System Interface (SAS) expanders that are coupled to each other in series. The stack includes two end expanders that are endpoints of the stack which are directly coupled to only one other SAS expander of the stack, and a plurality of middle expanders that are each directly coupled to two other SAS expanders of the stack. The system further includes a plurality of storage devices that are coupled to the SAS expanders of the stack, and a SAS storage controller comprising multiple SAS ports that are each directly coupled to a different SAS expander of the stack. At least one of the multiple SAS ports is directly coupled to a middle expander of the stack.

Other exemplary embodiments (e.g., methods and computer readable media relating to the foregoing embodiments) are also described below.

### BRIEF DESCRIPTION OF THE FIGURES

Some embodiments of the present invention are now described, by way of example only, and with reference to the accompanying figures. The same reference number represents the same element or the same type of element on all figures.

FIG. 1 is a block diagram of an exemplary storage system.

FIG. 2 is a block diagram of an exemplary Expander Bunch of Disks (EBOD).

FIG. 3 is a flowchart describing an exemplary method for operating a storage system.

FIGS. 4-6 are block diagrams illustrating further exemplary storage systems.

FIG. 7 illustrates an exemplary processing system operable to execute programmed instructions embodied on a computer readable medium.

### DETAILED DESCRIPTION OF THE FIGURES

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

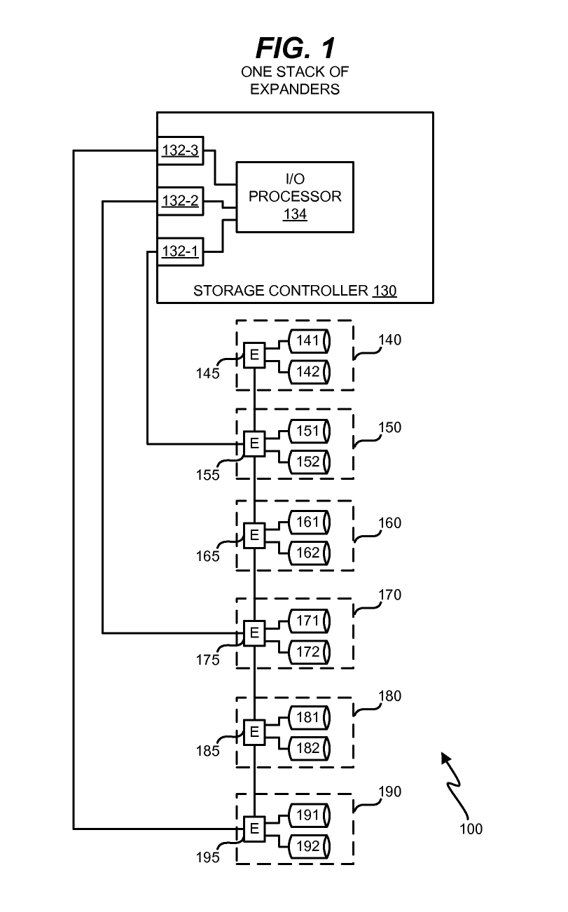

FIG. 1 is a block diagram of an exemplary SAS storage system 100. Storage system 100 comprises any suitable combination of components and devices for storing data on behalf of a host (e.g., a server) in accordance with SAS techniques. In this embodiment, storage system 100 comprises SAS storage controller 130 and multiple Expander Bunch of Disks (EBODs) (140, 150, 160, 170, 180, and 190). SAS storage controller includes multiple different direct connections to the EBODs to provide a variety of different signaling pathways for SAS connections.

Each EBOD comprises at least one SAS expander coupled to a plurality of storage devices that operate as SAS and/or Serial Advanced Technology Attachment (SATA) targets. EBOD 140 comprises SAS expander 145 and storage devices 141-142, EBOD 150 comprises SAS expander 155 and storage devices 151-152, EBOD 160 comprises SAS expander 165 and storage devices 161-162, EBOD 170 comprises SAS expander 175 and storage devices 171-172, EBOD 180 comprises SAS expander 185 and storage devices 181-182, and EBOD 190 comprises SAS expander 195 and storage devices 191-192.

The SAS expanders of the EBODs are connected with each other in series for communication to form a stack. A stack is a set of devices that are serially coupled/connected with each other for communication. That is, a stack of expanders exists in a “daisy chained” configuration and forms a line of directly coupled expanders. Each expander in a stack includes at least one SAS port that is directly coupled to a SAS port of another expander in the stack. Within the stack, the end expanders are directly coupled to only one other expander of the stack, while the middle expanders are directly coupled to two other expanders of the stack.

As used herein, the terms “serially coupled” and “series” are used to illustrate that each expander of a given stack does not include direct couplings with other expanders of the stack that would result in a configuration other than a “line” configuration. SAS devices are “directly coupled” when they include SAS ports that are physically attached to the same communication channel (e.g., cable), enabling communication between the SAS devices without an intervening SAS device (e.g., an intervening SAS expander).

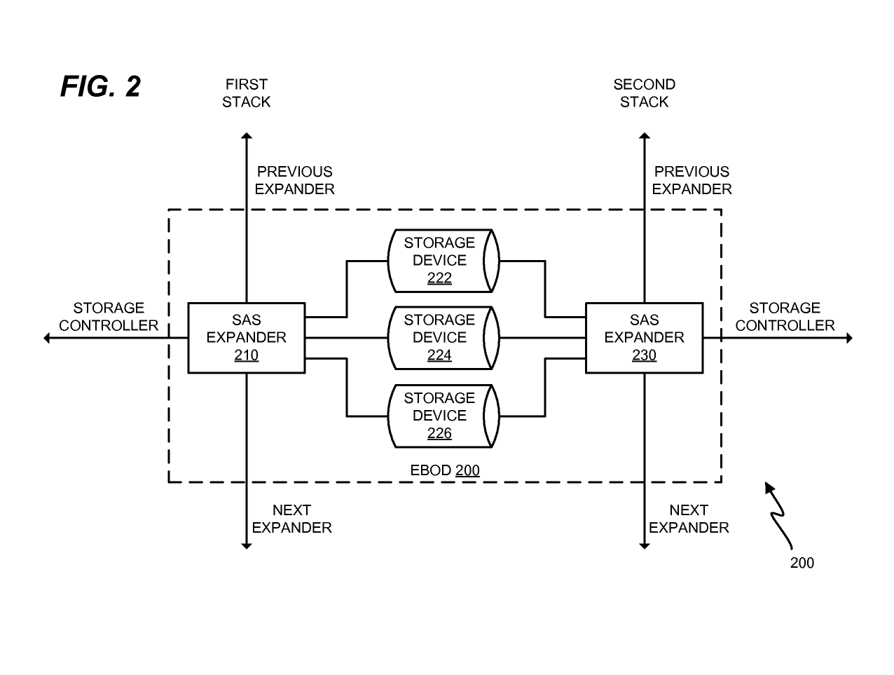

FIG. 2 illustrates a further exemplary EBOD 200 for use within a storage system. In this further example, the configuration of EBOD 200 is different than EBODs 140, 150, 160, 170, 180, and 190. Specifically, in EBOD 200, a SAS expander 210 and a SAS expander 230 are both directly coupled/connected with the same set of storage devices (222, 224, 226). SAS expanders 210 and 230 are each directly coupled to other SAS expanders of other EBODs to form a stack of expanders. Specifically, SAS expander 210 is part of a first stack of SAS expanders, while SAS expander 230 is part of a second stack of SAS expanders.

Returning to FIG. 1, storage controller 130 operates as a SAS initiator and is coupled for communication, via SAS ports 132, with the EBODs. Each SAS port 132 provides a different physical pathway for establishing SAS connections with the storage devices. Specifically, SAS port 132-1 is directly coupled to expander 155, SAS port 132-2 is directly coupled to expander 175, and SAS port 132-3 is directly coupled to SAS expander 195. This architecture provides a benefit by enhancing the redundancy of the storage system, and in ensuring that the shortest path length from storage controller 130 to any particular storage device remains small. Each SAS port 132 may comprise one or more SAS physical links (PHYs), operating as a narrow port or wide port as desired.

I/O processor 134 is operable to receive host requests, and to establish SAS connections with the storage devices of storage system 100 in order to read and/or write data in accordance with those host requests. Since there are multiple redundant pathways from storage controller 130 that may be utilized to access a given storage device, and since each pathway from storage controller 130 can have a different path length to a given storage device, I/O processor 134 actively selects a SAS port to utilize when establishing SAS connections with the storage devices (e.g., in order to select the shortest path for the SAS connection). In one embodiment, I/O processor 134 maintains and dynamically updates pathing information (e.g., a routing table) indicating an overall path length between each SAS port 132 and each storage device on storage system 100. I/O processor 134 can be implemented as custom circuitry, a processor executing programmed instructions stored in program memory, or some combination thereof.

The storage devices described herein (e.g., storage devices 222, 224, 226) implement persistent storage capacity for storage system 100, and are capable of writing and/or reading data in a computer readable format. For example, the storage devices can comprise magnetic hard disks, solid state drives, optical media, etc. compliant with protocols for SAS and/or SATA. In one embodiment, the storage devices implement storage space for one or more logical volumes. A logical volume comprises allocated storage space and data available at storage system 100, presented as a single storage device to the host. A logical volume can be implemented on any number of storage devices as a matter of design choice. Furthermore, the storage devices need not be dedicated to only one logical volume, but can also store data for a number of other logical volumes. In one embodiment, a logical volume is configured as a Redundant Array of Independent Disks (RAID) volume in order to enhance the performance and/or reliability of stored data.

Storage system 100 provides a benefit over prior systems, because storage controller 130 includes a plurality of different pathways for accessing storage devices via a stack of expanders. For example, instead of only providing access via one end of the stack or the other, the SAS ports of storage controller 130 are coupled “asymmetrically” throughout the stack, including to SAS expanders that are “middle expanders” of the stack. As used herein, an “asymmetric” set of couplings is one that is ordered differently when viewed from one end of the stack than when viewed from the other end of the stack. That is, the SAS ports of storage controller 130 are coupled to the stack in a staggered configuration, wherein each of the SAS ports is directly coupled with a different expander of the stack. This reduces the shortest path length between storage controller 130 and any given storage device, while also enhancing the redundancy of the storage system (e.g., in case an existing SAS port fails, is busy, etc.).

In prior systems, particularly in storage enclosures having specified and inflexible space requirements, it would have been prohibitively expensive to wire direct connections from a storage controller to the middle expanders of a stack, because this would have increased design costs, material costs, and manufacturing costs for a storage enclosure. Furthermore, there was no implemented technique for handling the complexity involved with selecting from such an increased number of signaling pathways. Even further, most storage controllers did not support a sufficient number of PHYs to support a large number of direct connections with SAS devices. Because of this, prior systems did not consider establishing direct connections to the middle expanders of a stack. The system of claim 1 provides a benefit over such prior systems, because it can take advantage of, for example, storage controllers with an enhanced PHY count in order to implement the architectures described above.

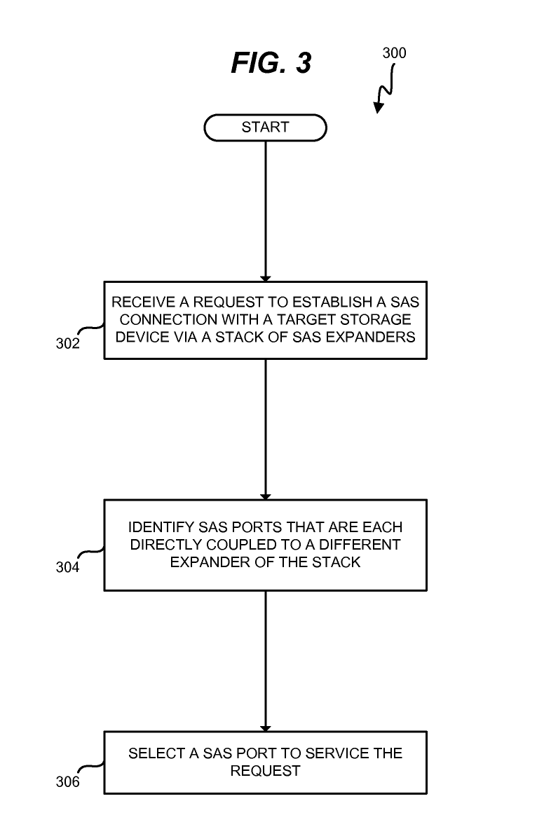

The particular arrangement, number, and configuration of components described herein is exemplary and non-limiting. Further details of the operation of storage system 100 will be explained with regard to FIG. 3. FIG. 3 is a flowchart 300 describing an exemplary method 300 for operating a storage system. Assume, for this embodiment, that storage system 100 includes multiple logical volumes of data (e.g., RAID volumes) that are managed by storage controller 130 and implemented on storage devices within the EBODs of FIG. 1.

Additionally, assume that a host has issued a request to access one of the logical volumes, and has transmitted the request for handling by storage controller 130. Storage controller 130 accesses logical-to-physical mapping information (e.g., RAID mapping information) stored in memory, and translates the host request into one or more SAS I/O operations for accessing the storage devices that implement the logical volume. For example, if the host request is a write request directed to a stripe of a RAID volume, I/O processor 134 can generate SAS I/O operations for each of the storage devices holding data for the RAID stripe. Each SAS I/O operation is directed to a specific storage device, and therefore one or more SAS connections with the storage devices should be established to transmit the SAS I/O operations.

To this end, in step 302 I/O processor 134 receives a request to establish a SAS connection with a target storage device (which is available via the stack of expanders) in order to transmit a SAS I/O operation. In one embodiment, this step is accomplished by selecting a recently generated SAS I/O operation awaiting transmission. In a further embodiment, the host request itself is treated as a request to establish one or more SAS connections. For example, a host request, once translated by I/O processor 134, can include a reference to a specific target SAS address.

In step 304, I/O processor 134 identifies SAS ports 132, which are each directly coupled to a different expander of the stack of storage system 100. Each of the SAS ports 132 is a candidate for providing a connection pathway to establish a SAS connection with the target storage device. In one embodiment, identifying the SAS ports 132 that are directly coupled to the stack comprises consulting mapping information to identify the SAS ports that provide a pathway to the target storage device.

Step 306 includes I/O processor 134 selecting a SAS port of the storage controller to service the request. I/O processor 134 can utilize any selection criteria desired to determine which SAS port 132 to utilize to service the connection. For example, this criteria can include an overall path length between each SAS port and the requested storage device (e.g., a number of intervening expanders between the SAS ports and the requested target storage device), an expected latency for a connection between each SAS port and the requested storage device, whether or not a given SAS port is currently unavailable, a width of the SAS port in PHYs, a maximum data rate of each SAS port, an amount of noise or a current speed-negotiated data rate, an expected period of time to establish a SAS connection via the pathway, etc. Once the appropriate SAS port has been selected, I/O processor 134 operates the selected SAS port in accordance with SAS techniques to establish a SAS connection with the target storage device and transmit SAS I/O operations. For example, I/O processor 134 can generate an OPEN Address Frame for transmission via the selected SAS port in order to establish a SAS connection. In this manner, data is efficiently transferred in accordance with the host request via an optimal pathway. Steps 302-306 can be repeated multiple times when a host request refers to multiple target devices.

Method 300 provides a benefit over prior SAS methods, because it utilizes a storage controller that considers a variety of different available pathways for accessing a storage device, including pathways that directly connect the storage controller to a middle expander of a stack of SAS expanders. This type of SAS architecture reduces the overall path length for SAS connections, enhancing overall data rate and reducing latency. Even though the steps of method 300 are described with reference to storage system 100 of FIG. 1 wherein there is only a single stack of SAS expanders, method 300 can be performed in other systems that include multiple stacks of SAS expanders. The steps of the flowcharts described herein are not all inclusive and can include other steps not shown. The steps described herein can also be performed in an alternative order.

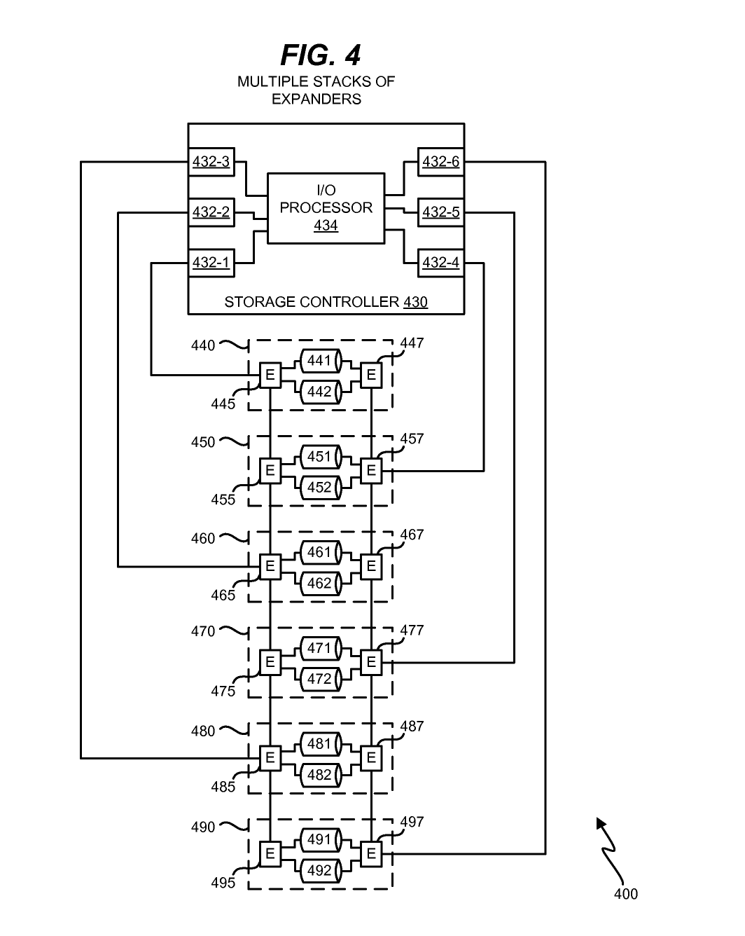

The following discussion illustrates a variety of storage systems that include a storage controller having access to a variety of physical pathways for accessing stacks of SAS expanders. Specifically, FIGS. 4-6 are block diagrams illustrating further exemplary storage systems.

FIG. 4 is a block diagram that illustrates an exemplary storage system 400 wherein a storage controller 430 includes multiple SAS ports (432-1, 432-2, 432-3, 432-4, 432-5, and 432-6) that each provide a different physical pathway for accessing a plurality of storage devices accessible via a stack of SAS expanders. In this example, there are two separate stacks of storage controllers that are coupled to each other in series. The first stack comprises expanders 445, 455, 465, 475, 485, and 495. The second stack comprises expanders 447, 457, 467, 477, 487, and 497. Furthermore, in this embodiment, SAS ports 432-1, 432-2, and 432-3 are directly coupled to expanders of the first stack, while SAS ports 432-4, 432-5, and 432-6 are directly coupled to expanders of the second stack. Thus, storage controller 430 includes two different sets of SAS ports for accessing two different stacks of SAS expanders. For a given SAS connection, I/O processor 434 is operable to select the SAS port of storage controller 430 that provides the shortest path length (e.g., “hop count”) to the requested target device. In one embodiment, I/O processor 434 selects the shortest path available via only one stack, while in further embodiments I/O processor 534 selects the shortest path length found via any of the stacks.

In this embodiment, as shown in FIG. 4, EBOD 440 comprises SAS expander 445, SAS expander 447, and storage devices 441-442, EBOD 450 comprises SAS expander 455, SAS expander 457, and storage devices 451-452, EBOD 460 comprises SAS expander 465, SAS expander 467, and storage devices 461-462, EBOD 470 comprises SAS expander 475, SAS expander 477, and storage devices 471-472, EBOD 480 comprises SAS expander 485, SAS expander 487, and storage devices 481-482, and EBOD 490 comprises SAS expander 495, SAS expander 497, and storage devices 491-492.

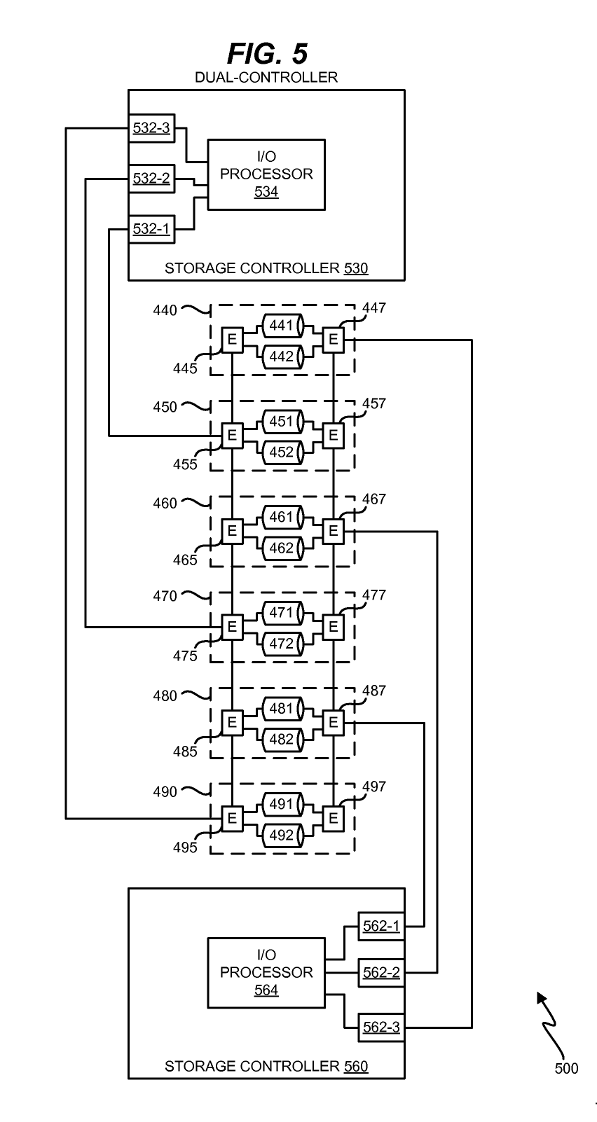

FIG. 5 is a block diagram that illustrates a further exemplary storage system 500, wherein multiple storage controllers share access to the storage devices and expanders illustrated in FIG. 4. As shown in FIG. 5, storage controller 530 comprises I/O processor 534 and SAS ports 532-1, 532-2, and 532-3. Thus, storage controller 530 accesses a first stack of SAS expanders comprising SAS expanders 445, 455, 465, 475, 485, and 495. Meanwhile, storage controller 560 comprises I/O processor 564 and SAs ports 562-1, 562-2, and 562-3. Thus, storage controller 560 accesses a second stack of SAS expanders comprising SAS expanders 447, 457, 467, 477, 487, and 497. I/O processor 534 utilizes a shortest path algorithm to manage SAS connections via the first stack, while I/O processor 564 utilizes a shortest path algorithm to manage SAS connections via the second stack.

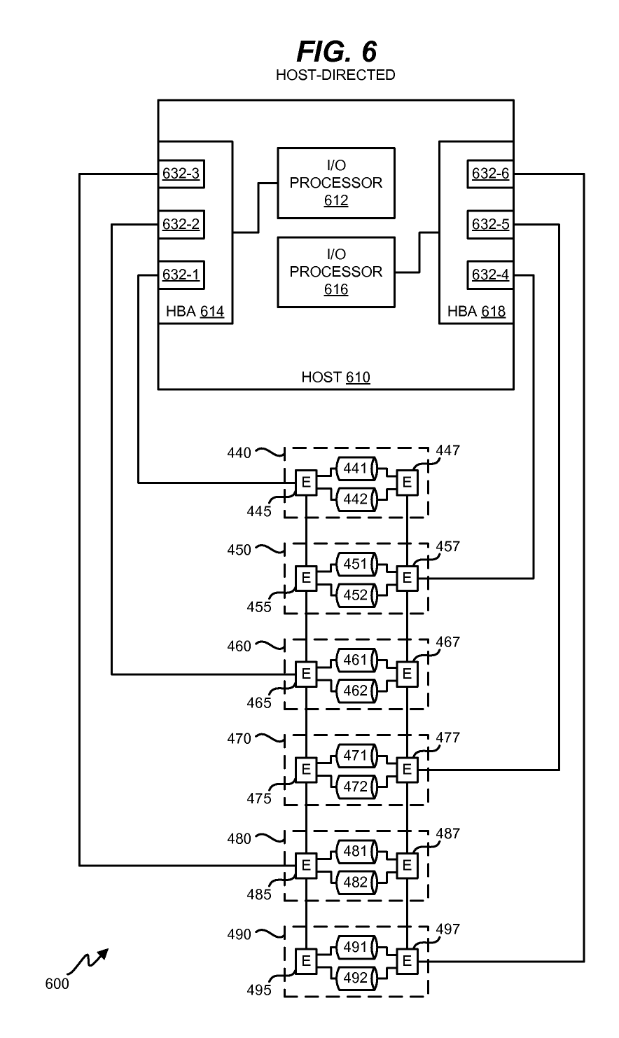

FIG. 6 is a block diagram illustrating a further exemplary storage system 600. In FIG. 6, host 610, utilizes a memory and processor (not shown) to operate a mid-level driver to select a SAS port to utilize to establish a SAS connection with a downstream storage device, utilizing the same set of expanders and storage devices previously described in FIG. 4. Implementing path selection at the host level can provide a benefit for hosts that implement Fast Path techniques developed by LSI Corporation, a subsidiary of Avago Technologies. In this embodiment, the mid-level driver is capable of contacting I/O processor 612, which manages the operations of ports 632-1, 632-2, and 632-3 of HBA 614, and the mid-level driver is also capable of contacting I/O processor 616, which manages the operations of ports 632-4, 632-5, and 632-6 of HBA 618.

The mid-level driver retrieves mapping information from the HBAs to determine a correlation between Logical Block Addresses (LBAs) requested by the host Operating System (OS), and storage devices available on storage system 600. In this embodiment, the driver is capable of identifying a target storage device for a SAS I/O operation, such as a SAS I/O operation that is about to be generated based on input from an Operating System (OS) and logical-to-physical mapping information maintained at the driver. The driver is further capable of identifying HBA and/or SAS ports of the storage controller that each provide a different signaling pathway to the target storage device via a stack of serially coupled SAS expanders. Each SAS port is directly coupled to a different SAS expander of the stack, and at least one of the SAS ports is directly coupled to a middle expander of the stack. Further, the driver is capable of selecting one of the HBAs and/or SAS ports (e.g., based on the mapping information and/or the criteria listed above with respect to method 300), and transmitting a request to a SAS address of the selected SAS port instructing the SAS port to establish a SAS connection with the target storage device for transmitting the I/O operation.

Similar techniques to those described above can be utilized in a multi-controller environment. For example, these techniques can be used in order for the mid-level driver to select not just a specific SAS port, but also a specific storage controller via which to establish a SAS connection. In yet a further embodiment, both a driver at the host and the storage controller itself implement a shortest-path algorithm. This may be desirable in embodiments where the host and storage controller(s) are aware of different portions of the overall storage system.

### EXAMPLES

In the following examples, additional processes, systems, and methods are described in the context of a storage system with a storage controller that includes a variety of physical pathways for accessing stacks of SAS expanders.

In this example illustrated at FIG. 4, storage controller 430 is implemented as a Peripheral Component Interconnect Express (PCIE) card operating as an HBA for a host system comprising a server. Storage controller 430 includes I/O processor 434, which comprises a processor and a memory storing instructions for processing host requests received via the PCIE interface. In this example, the twelve storage devices of storage system 400 implement a six-storage device RAID level 5 volume that is mirrored onto the other six storage devices. Furthermore, storage controller 430 includes twenty-four PHYs, wherein each of the SAS ports 432-1 through 432-6 comprises a SAS wide port 4 PHYs in width.

When an incoming host request is received via the PCIE interface, I/O processor 434 determines the LBAs of the RAID volume that are referenced by the host request. That is, I/O processor 434 determines the identity (indicated by a SAS address) of each storage device that will be accessed to service the host request by consulting internally stored RAID mapping information. In this example, the host request is a full-stripe write that will result in a write to all storage devices of the RAID 5 volume, as well as all storage devices that mirror the RAID 5 volume. I/O processor 434 therefore generates SAS I/O operations directed to each of the storage devices. When SAS I/O operations have been generated for a storage device, I/O processor 434 reviews an internally stored routing table to determine the path length to the storage device via each of the SAS ports that is presently available (e.g., not presently occupied servicing a connection). I/O processor 434 then directs the SAS I/O to the SAS address of that port in order to establish a connection with the storage device via the shortest available path.

In this example, I/O processor 434 picks the initiator to target path which crosses the fewest number of expanders, since each expander connection adds to overall latency. The I/O processor determines the shortest path based on a table that correlates target port SAS addresses, expander hop counts (i.e., the number of intervening expanders along the signaling pathway), and initiator port SAS addresses. The entries of the table are sorted based on expander hop count from low-to-high for each target port, and I/O processor 434 selects the initiator port with the lowest hop count.

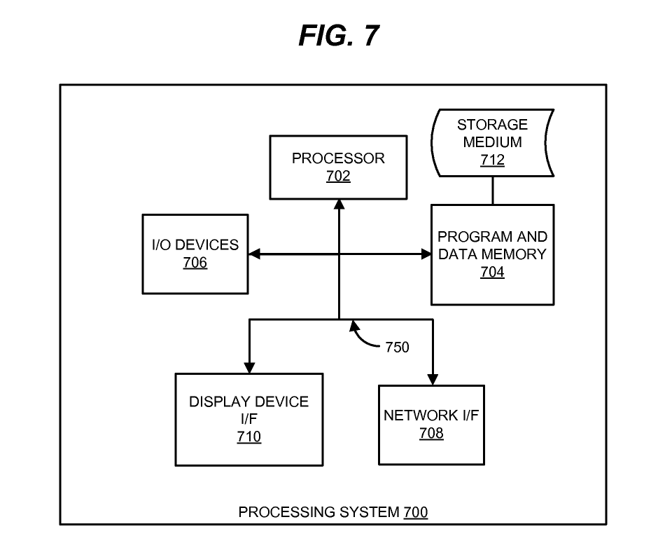

Embodiments disclosed herein can take the form of software, hardware, firmware, or various combinations thereof In one particular embodiment, software is used to direct a processing system of storage system 100 to perform the various operations disclosed herein. FIG. 7 illustrates an exemplary processing system 700 operable to execute a computer readable medium embodying programmed instructions. Processing system 700 is operable to perform the above operations by executing programmed instructions tangibly embodied on computer readable storage medium 712. In this regard, embodiments of the invention can take the form of a computer program accessible via computer readable medium 712 providing program code for use by a computer (e.g., processing system 700) or any other instruction execution system. For the purposes of this description, computer readable storage medium 712 can be anything that can contain or store the program for use by the computer (e.g., processing system 700).

Computer readable storage medium 712 can be an electronic, magnetic, optical, electromagnetic, infrared, or semiconductor device. Examples of computer readable storage medium 712 include a solid state memory, a magnetic tape, a removable computer diskette, a random access memory (RAM), a read-only memory (ROM), a rigid magnetic disk, and an optical disk. Current examples of optical disks include compact disk—read only memory (CD-ROM), compact disk—read/write (CD-R/W), and DVD.

Processing system 700, being used for storing and/or executing the program code, includes at least one processor 702 coupled to program and data memory 704 through a system bus 750. Program and data memory 704 can include local memory employed during actual execution of the program code, bulk storage, and cache memories that provide temporary storage of at least some program code and/or data in order to reduce the number of times the code and/or data are retrieved from bulk storage during execution.

Input/output or I/O devices 706 (including but not limited to keyboards, displays, pointing devices, etc.) can be coupled either directly or through intervening I/O controllers. Network adapter interfaces 708 can also be integrated with the system to enable processing system 700 to become coupled to other data processing systems or storage devices through intervening private or public networks. Modems, cable modems, IBM Channel attachments, SCSI, Fibre Channel, and Ethernet cards are just a few of the currently available types of network or host interface adapters. Display device interface 710 can be integrated with the system to interface to one or more display devices, such as printing systems and screens for presentation of data generated by processor 702.

What is claimed is:

1. A system comprising:
a stack of Serial Attached Small Computer System Interface (SAS) expanders that are coupled to each other in series, comprising:
two end expanders that are endpoints of the stack which are directly coupled to only one other SAS expander of the stack; and
a plurality of middle expanders that are each directly coupled to two other SAS expanders of the stack;
a plurality of storage devices that are coupled to the SAS expanders of the stack; and
a SAS storage controller comprising multiple SAS ports that are each directly coupled to a different SAS expander of the stack, wherein at least one of the multiple SAS ports is directly coupled to a middle expander of the stack.

2. The system of claim 1, wherein:
each of the SAS ports is capable of establishing a SAS connection with any of the plurality of storage devices.

3. The system of claim 1, wherein:
each of the SAS ports utilizes a pathway comprising a different set of intervening SAS expanders to access a target storage device.

4. The system of claim 1, wherein:
the SAS storage controller further comprises an Input/Output (I/O) processor operable to select one of the SAS ports for servicing a requested SAS connection to a target storage device, based on a number of intervening SAS expanders between each of the SAS ports and the target storage device.

5. The system of claim 1, wherein:
the SAS storage controller further comprises an Input/Output (I/O) processor operable to select one of the SAS ports for servicing a requested SAS connection to a target storage device, based on an anticipated latency of each pathway used by the SAS ports to establish the SAS connection.

6. A method for operating a Serial Attached Small Computer System Interface (SAS) device, the method comprising:
receiving a request to establish a SAS connection with a target storage device via a stack of SAS expanders that are coupled to each other in series;
identifying SAS ports of the storage controller that are each directly coupled to a different SAS expander of the stack, wherein at least one of the SAS ports is directly coupled to a middle expander of the stack; and
selecting a SAS port of the SAS storage controller to service the request.

7. The method of claim 6, further comprising:
determining that each of the SAS ports is capable of establishing a SAS connection with any storage device coupled to the stack.

8. The method of claim 6, further comprising:
determining that each of the SAS ports utilizes a pathway comprising a different set of intervening SAS expanders to access the target storage device.

9. The method of claim 6, wherein:
selecting a SAS port is based on a number of intervening SAS expanders between each of the SAS ports and the target storage device.

10. The method of claim 6, wherein:
selecting a SAS port is based on an anticipated latency of each pathway used by the SAS ports to establish the SAS connection.

11. A non-transitory computer readable medium embodying programmed instructions which, when executed by a processor of a storage controller, are operable for directing the processor to:
receive a request to establish a SAS connection with a target storage device via a stack of SAS expanders that are coupled to each other in series;
identify SAS ports of the storage controller that are each directly coupled to a different SAS expander of the stack, wherein at least one of the SAS ports is directly coupled to a middle expander of the stack; and
select a SAS port of the SAS storage controller to service the request.

12. The medium of claim 11, wherein the instructions further direct the processor to:
determine that each of the SAS ports is capable of establishing a SAS connection with any storage device coupled to the stack.

13. The medium of claim 11, wherein the instructions further direct the processor to:
determine that each of the SAS ports utilizes a pathway comprising a different set of intervening SAS expanders to access the target storage device.

14. The medium of claim 11, wherein:
selecting a SAS port is based on a number of intervening SAS expanders between each of the SAS ports and the target storage device.

15. The medium of claim 11, wherein:
selecting a SAS port is based on an anticipated latency of each pathway used by the SAS ports to establish the SAS connection.

16. A non-transitory computer readable medium embodying programmed instructions which, when executed by a processor of a host computer, are operable for directing a driver of the host computer to:
identify a target storage device for a Serial Attached Small Computer System Interface (SAS) Input/Output (I/O) operation;
identify SAS ports that each provide a signaling pathway to the target storage device via a stack of serially coupled SAS expanders, wherein each SAS port is directly coupled to a different SAS expander of the stack, and at least one of the SAS ports is directly coupled to a middle expander of the stack;
select one of the SAS ports; and
transmit a request to a SAS address of the selected SAS port instructing the SAS port to establish a SAS connection with the target storage device for transmitting the I/O operation.

17. The medium of claim 16, wherein:
each of the SAS ports is capable of establishing a SAS connection with any storage device coupled to the stack.

18. The medium of claim 16, wherein:
each of the SAS ports utilizes a pathway comprising a different set of intervening SAS expanders to access the target storage device.

19. The medium of claim 16, wherein the instructions further direct the driver to:
select the SAS port based on a number of intervening SAS expanders between each of the SAS ports and the target storage device.

20. The medium of claim 16, wherein the instructions further direct the driver to:
select the SAS port based on an anticipated latency of each pathway used by the SAS ports to establish the SAS connection.

21. A system comprising:
a Serial Attached Small Computer System Interface (SAS) storage controller that is coupled to a stack of SAS expanders, the SAS expanders of the stack being coupled to each other in series,
wherein the stack comprises two end expanders that are endpoints of the stack which are directly coupled to only one other SAS expander of the stack, and a plurality of middle expanders that are each directly coupled to two other SAS expanders of the stack,
the storage controller comprising:
multiple SAS ports that are each directly coupled to a different SAS expander of the stack, wherein at least one of the multiple SAS ports is directly coupled to a middle SAS expander of the stack; and
an I/O processor operable to receive a request to establish a SAS connection with a target storage device coupled to the stack, and to select a SAS port of the storage controller to service the request.

22. The system of claim 21, wherein:
each of the SAS ports is capable of establishing a SAS connection with any storage device coupled to the stack.

23. The system of claim 21, wherein:
each of the SAS ports utilizes a pathway comprising a different set of intervening SAS expanders to access the target storage device.

24. The system of claim 21, wherein:
the I/O processor is further operable to select one of the SAS ports for servicing a requested SAS connection to the target storage device, based on a number of intervening SAS expanders between each of the SAS ports and the target storage device.

25. The system of claim 21, wherein:
the I/O processor is further operable to select one of the SAS ports for servicing a requested SAS connection to the target storage device, based on an anticipated latency of each pathway used by the SAS ports to establish the SAS connection.
